(19) United States
(12) Patent Application Publication
(10) Pub. No.: US 2021/0345094 A1
(43) Pub. Date: Nov. 4, 2021

(54) VEHICULAR COMMUNICATION DEVICE, VEHICULAR COMMUNICATION METHOD AND CONTROL PROGRAM PRODUCT

(71) Applicant: DENSO CORPORATION, Kariya-city (JP)

(72) Inventor: Yuichiro KOGA, Kariya-city (JP)

(21) Appl. No.: 17/373,356

(22) Filed: Jul. 12, 2021

Related U.S. Application Data
(63) Continuation of application No. PCT/JP2019/050357, filed on Dec. 23, 2019.

(30) Foreign Application Priority Data
Jan. 17, 2019 (JP) 2019-006271

(51) Int. Cl. H04W 8/22; H04W 4/40

(52) U.S. Cl. CPC H04W 8/22; H04W 4/40

(57) ABSTRACT

A vehicular communication device is configured to specify a current position of a vehicle, determine whether the current position of the vehicle is inside or outside a specific area in which use of a radio wave in a predetermined frequency band is permitted, periodically transmit information on the radio wave in response to determining that the current position of the vehicle is inside the specific area, and stop transmission of the radio wave in response to determining that the current position of the vehicle is outside the specific area.

### CROSS REFERENCE TO RELATED APPLICATIONS

The present application is a continuation application of International Patent Application No. PCT/JP2019/050357 filed on Dec. 23, 2019, which designated the U.S. and claims the benefit of priority from Japanese Patent Application No. 2019-006271 filed on Jan. 17, 2019. The entire disclosures of all of the above applications are incorporated herein by reference.

### TECHNICAL FIELD

The present disclosure relates to a vehicular communication device, a vehicular communication method, and a control program product.

### BACKGROUND

There has been known a vehicular communication devices used for vehicles and transmit and receive information by wireless communication. For example, there has been known a technique in which each vehicle periodically transmits information such as a current position, a traveling speed, and a traveling direction to peripheral vehicles by vehicle-to-vehicle communication.

### SUMMARY

The present disclosure provides a vehicular communication device, a vehicular communication method, and a control program product that specify a current position of a vehicle, determine whether the current position of the vehicle is inside or outside a specific area in which use of a radio wave in a predetermined frequency band is permitted, periodically transmit information on the radio wave in response to determining that the current position of the vehicle is inside the specific area, and stop transmission of the radio wave in response to determining that the current position of the vehicle is outside the specific area.

### BRIEF DESCRIPTION OF DRAWINGS

Objects, features and advantages of the present disclosure will become apparent from the following detailed description made with reference to the accompanying drawings. In the drawings:

FIG. 1 is a diagram showing an example of a schematic configuration of a vehicular system according to a first embodiment;

FIG. 2 is a schematic diagram for explaining an example of transmission permitted area data;

FIG. 3 is a flowchart showing an example of a flow of transmission-related process in a vehicular communication device according to the first embodiment;

FIG. 4 is a diagram showing an example of a schematic configuration of a vehicular system according to a second embodiment;

FIG. 5 is a flowchart showing an example of a flow of transmission-related process in a vehicular communication device according to the second embodiment;

FIG. 6 is a diagram showing an example of a schematic configuration of a vehicular system according to a third embodiment; and

FIG. 7 is a flowchart showing an example of a flow of transmission-related process in a vehicular communication device according to the third embodiment.

### DETAILED DESCRIPTION

Frequency bands of radio waves permitted to be used may differ by region. When a vehicle travels across the region while periodically transmitting information by wireless communication, there is a possibility of outputting radio waves that are not permitted to be used. Although it is conceivable that a user turns off the power of a vehicular communication device when entering a region where use of the radio wave output by a subject device is not permitted, the effort of the user may increase.

A vehicular communication device to be used for a vehicle according to one aspect of the present disclosure includes a transmission controller, a position specifier, and an inside-outside determiner. The transmission controller is configured to periodically transmit information on a radio wave in a predetermined frequency band. The position specifier is configured to specify a current position of the vehicle. The inside-outside determiner is configured to determine whether the current position of the vehicle specified by the position specifier is inside or outside a specific area in which use of the radio wave is permitted. The transmission controller is further configured not to stop transmission of the radio wave in response to that the inside-outside determiner determines that the current position of the vehicle is inside the specific area, and to stop transmission of the radio wave in response to that the inside-outside determiner determines that the current position of the vehicle is outside the specific area.

A communication method for a vehicle according to another aspect of the present disclosure includes specifying a current position of the vehicle, determining whether the current position of the vehicle is inside or outside a specific area in which use of a radio wave in a predetermined frequency band is permitted, periodically transmitting information on the radio wave in response to determining that the current position of the vehicle is inside the specific area, and stopping transmission of the radio wave in response to determining that the current position of the vehicle is outside the specific area.

A control program product according to another aspect of the present disclosure is stored on a non-transitory computer-readable medium and includes instructions configured to, when executed by a computer, cause the computer to: specify a current position of a vehicle; determine whether the current position of the vehicle is inside or outside a specific area in which use of a radio wave in a predetermined frequency band is permitted; periodically transmit information on the radio wave in response to determining that the current position of the vehicle is inside the specific area; and stop transmission of the radio wave in response to determining that the current position of the vehicle is outside the specific area.

According to the above configurations, when it is determined that the current position of the vehicle is outside the specific area in which use of radio wave in the predetermined frequency band is permitted, it is possible to stop transmission of the radio wave outside the specific area without turning off the power of the vehicular communication device by the user. When it is determined that the vehicle is inside the specific area in which use of the radio wave in the predetermined frequency band is permitted, it is possible to periodically transmit information on the radio wave without stopping the radio wave. Therefore, it is possible to suppress the output of the radio wave that is not permitted to be used while saving the effort of the user.

### First Embodiment

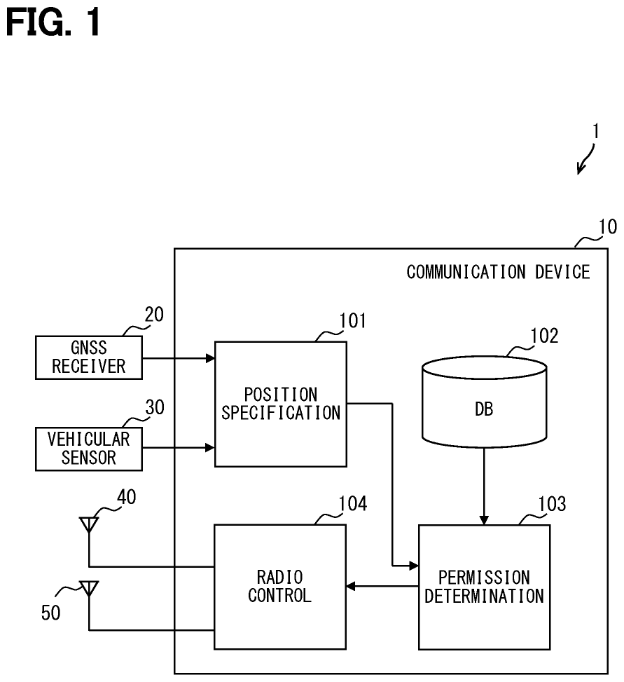

Hereinafter, a first embodiment of the present disclosure will be described with reference to the drawings. The vehicular system 1 shown in FIG. 1 is used in a vehicle. Hereinafter, the vehicle in which the vehicular system 1 is used is also referred to as a subject vehicle. As shown in FIG. 1, the vehicular system 1 includes a vehicular communication device 10, a global navigation satellite system (GNSS) receiver 20, a vehicle sensor 30, a transmission antenna 40, and a reception antenna 50.

The GNSS receiver 20 receives positioning signals from positioning satellites constituting the GNSS. The vehicular sensor 30 is a sensor group for detecting each state of a subject vehicle, and includes a behavior sensor that detects a physical state amount related to a behavior of the subject vehicle and an operation state sensor for detecting an operation state of the subject vehicle. The behavior sensor includes a vehicle speed sensor that detects a vehicle speed of the subject vehicle, a steering sensor that detects a steering angle of the subject vehicle, and a yaw rate sensor that detects a yaw rate of the subject vehicle, or the like. The operation state sensor includes, an accelerator position sensor that detects an opening degree of an accelerator pedal of the subject vehicle, a brake pedaling force sensor that detects the pedaling amount of a brake pedal of the subject vehicle, or the like.

The transmission antenna 40 transmits information on a radio wave in a predetermined frequency band. The predetermined frequency band is a frequency band according to a communication standard used for wireless communication with vehicles. As an example, a frequency band conforming to a dedicated short range communication (DSRC) standard may be used. For example, the predetermined frequency band may be a frequency band of 5.9 GHz or the like. Hereinafter, a radio wave in this predetermined frequency band will be referred to as a specific radio wave. The reception antenna 50 receives the specific radio wave that is transmitted. In the present embodiment, the vehicular system 1 uses the transmission antenna 40 and the reception antenna 50 to perform vehicle-to-vehicle communication with the vehicular system 1 used by a peripheral vehicle present in the vicinity of the subject vehicle.

The description will be given by taking the case where the vehicular system 1 performs vehicle-to-vehicle communication as an example, but the present disclosure is not limited to vehicle-to-vehicle communication. For example, the vehicular system 1 may be configured to perform road-to-vehicle communication with roadside units in the vicinity of the subject vehicle by using the transmission antenna 40 and the reception antenna 50. Further, the vehicular system 1 may be configured to perform pedestrian-to-vehicle communication with a mobile terminal carried by a pedestrian in the vicinity of the subject vehicle using the transmission antenna 40 and the reception antenna 50.

The vehicular communication device 10 includes, for example, a processor, a memory, an I/O, and a bus connecting these components, and executes various processes related to wireless communication by executing a control program stored in the memory. The vehicular communication device 10 transmits information on the specific radio wave from the transmission antenna 40, or acquires information received by the reception antenna 50. The various processes related to wireless communication also include a process related to transmission of information on the specific radio wave from the transmission antenna 40 (hereinafter, transmission-related process). Further, a computer performing each step of the transmission-related process corresponds to execution of a vehicular communication method. The memory mentioned in the above is a non-transitory tangible storage medium that non-temporarily stores computer-readable program and data. The non-transitory tangible storage medium may be provided by a semiconductor memory or a magnetic disk. The details of the vehicular communication device 10 will be described below.

An example of a schematic configuration of the vehicular communication device 10 will be described with reference to FIG. 1. As shown in FIG. 1, the vehicular communication device 10 includes a position specification unit 101, a permitted area database (hereinafter, permitted area DB) 102, a permission determination unit 103, and a radio control unit 104 as functional blocks. A part or all of the functions executed by the vehicular communication device 10 may be configured by hardware using one or more ICs or the like. Alternatively, a part or all of the functional blocks of the vehicular communication device 10 may be implemented by a combination of software executed by a processor and hardware.

The position specification unit 101 positions the current position of the subject vehicle by combining the positioning signal received by the GNSS receiver 20 and the yaw rate detected by the yaw rate sensor of the vehicle sensor 30, and specifies the current position of the subject vehicle. For the positioning of the current position, a travel distance obtained from detection results sequentially output from the vehicle speed sensor of the vehicle sensor 30 may also be used. The current position of the subject vehicle may be represented by the coordinates of latitude and longitude. The position specification unit 101 may be configured to specify the current position of the subject vehicle on a road by map matching on a road link using map data.

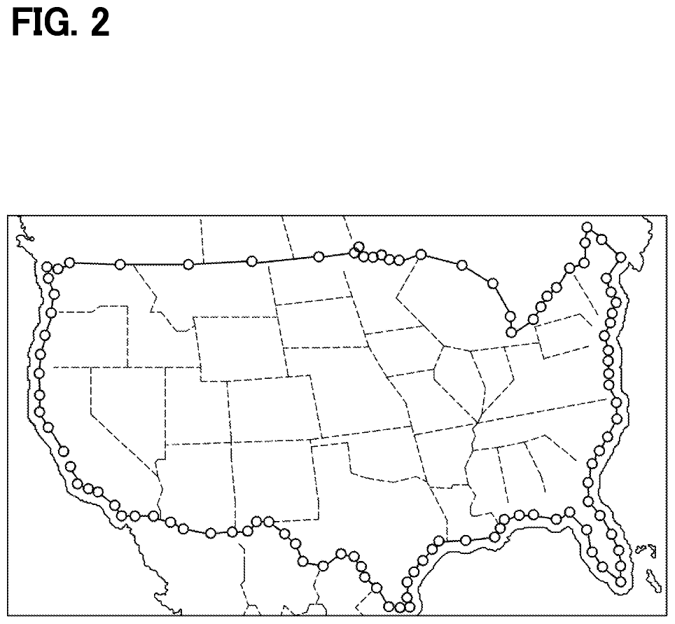

The permitted area DB 102 stores transmission permitted area data which is information indicating an area (hereinafter, a specific area) in which use of the specific radio wave output from the transmission antenna 40 is permitted. Permitting use of the specific radio wave means, for example, that use of the specific radio wave is permitted by the Radio Law. A non-volatile memory may be used as the permitted area DB 102. As an example, the transmission permitted area data may be configured to use a point group (see the white circle in FIG. 2) of latitude and longitude coordinates representing the boundary of the specific area. Accordingly, a range of the specific area can be indicated as a range within a frame connecting this point group. FIG. 2 is a schematic diagram for explaining an example of transmission permitted area data. It is assumed that the specific area is set in advance and stored in the permitted area DB 102.

The permission determination unit 103 determines whether or not to permit the output of the radio wave from the transmission antenna 40 (hereinafter, radio transmission permission determination). The permission determination unit 103 determines whether the current position of the subject vehicle specified by the position specification unit 101 is inside or outside the specific area indicated by the information stored in the permitted area DB 102. For example, the determination of whether the subject vehicle is inside or outside the specific area may be determined based on whether or not the coordinates indicating the current position of the subject vehicle are within the range of the specific area. The permission determination unit 103 corresponds to an inside-outside determiner. Then, when the permission determination unit 103 determines that the current position of the subject vehicle is inside the specific area, the permission determination unit 103 determines to permit the output of the radio wave from the transmission antenna 40 (hereinafter, transmission permission). When the permission determination unit 103 determines that the current position of the subject vehicle is outside the specific area, the permission determination unit 103 determines not to permit the output of the radio wave from the transmission antenna 40.

When the power of the subject vehicle is turned on, the permission determination unit 103 determines whether the current position of the subject vehicle is inside or outside the specific area, and determines whether or not to permit transmission of the radio wave. Then, the determination result by the permission determination unit 103 is held until the power of the subject vehicle is turned off. For example, the permission determination unit 103 may hold the determination result in a volatile memory. When a traveling drive source of the subject vehicle is an internal combustion engine, power-on and power-off correspond to on and off of an ignition switch, which is a switch for starting the internal combustion engine. When the traveling drive source of the subject vehicle is a motor generator, power-on and power-off correspond to on and off of a power switch, which is a switch for starting the motor generator. In order to reduce the processing load, the position specification unit 101 may be configured not to specify again the current position of the subject vehicle until the power of the subject vehicle is turned off after specifying the current position of the subject vehicle when the power of the subject vehicle is turned on. Alternatively, the position specification unit 101 may be configured to sequentially specify the current position of the subject vehicle.

The radio control unit 104 periodically transmits information on the specific radio wave from the transmission antenna 40. The radio control unit 104 corresponds to the transmission controller. As an example, the transmission antenna 40 may transmit the current position of the subject vehicle specified by the position specification unit 101, the sensing result by the vehicular sensor 30, and the like. In addition, the radio control unit 104 acquires information transmitted from a peripheral vehicle on the specific radio wave and received by the reception antenna 50. As an example, the radio control unit 104 may acquire the current position of the peripheral vehicle, the sensing result of the vehicular sensor 30 of the peripheral vehicle, and the like. The radio control unit 104 outputs the acquired current position of the peripheral vehicle, the sensing result of the vehicular sensor 30 of the peripheral vehicle, and the like to a driving support device that provides support such as driving support at an intersection based on the information.

In response to that the permission determination unit 103 determines to permit transmission, the radio control unit 104 causes the transmission antenna 40 to periodically transmit information on the specific radio wave. In response to that the permission determination unit 103 determines not to permit transmission, the radio control unit 104 prohibits the output of the specific radio wave from the transmission antenna 40 to stop the transmission. That is, the radio control unit 104 does not stop transmission of the specific radio wave in response to that the permission determination unit 103 determines that the current position of the subject vehicle is inside the specific area, while the radio control unit 104 stops transmission of the specific radio wave in response to that the permission determination unit 103 determines that the current position of the subject vehicle is outside the specific area.

From power-on to power-off of the subject vehicle, the radio control unit 104 fixes whether or not to stop transmission of the specific radio wave according to the determination result by the permission determination unit 103 when the power of the subject vehicle is turned on. Specifically, the radio control unit 104 periodically transmits the information on the specific radio wave from the transmission antenna until the power of the subject vehicle is turned off in response to that the permission determination unit 103 determines to permit transmission when the power of the subject vehicle is turned off. On the other hand, the radio control unit 104 stops transmission of the specific radio wave until the power of the subject vehicle is turned off in response to that the permission determination unit 103 determines not to permit transmission when the power of the subject vehicle is turned on.

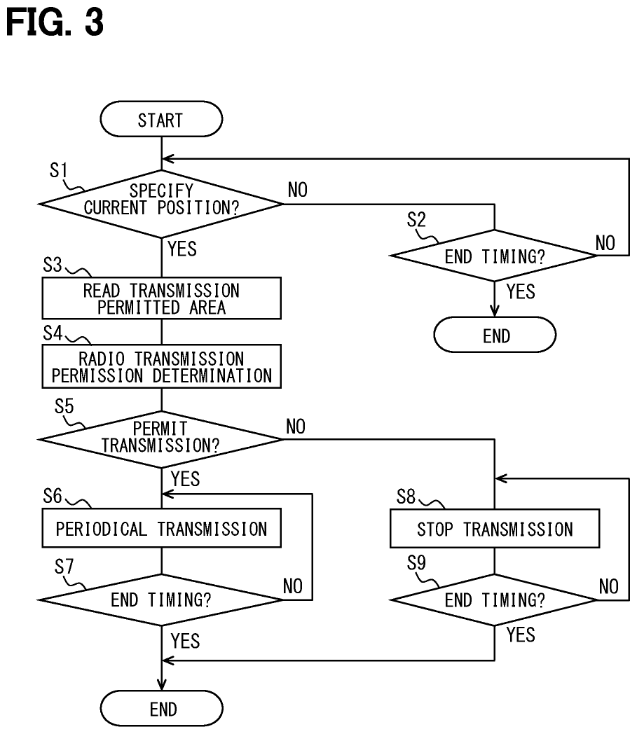

An example of a flow of the transmission-related process in the vehicular communication device 10 will be described with reference to the flowchart of FIG. 3. The vehicular communication device 10 may start the flowchart of FIG. 3 when the power of the subject vehicle is turned on.

In S1, when the current position of the subject vehicle is specified by the position specification unit 101 (YES in S1), the process proceeds to S3. If the current position of the subject vehicle is not specified by the position specification unit 101 (NO in S1), the process proceeds to S2. In S2, when it is an end timing of the transmission-related process (YES in S2), the transmission-related process is ended. When it is not the end timing of the transmission-related process (NO in S2), the process returns to S1 and the process is repeated. An example of the end timing of the transmission-related process is that the power of the subject vehicle is turned off.

In S3, the permission determination unit 103 reads the transmission permitted area data from the permitted area DB 102. In S4, the permission determination unit 103 determines whether the current position of the subject vehicle is inside or outside the specific area from the current position of the subject vehicle specified in S1 and the transmission permitted area data read in S3. Then, when the permission determination unit 103 determines that the current position of the subject vehicle is inside the specific area, the permission determination unit 103 determines to permit transmission of the specific radio wave. When the permission determination unit 103 determines that current position of the subject vehicle is outside the specific area, the permission determination unit 103 determines not to permit transmission of the specific radio wave.

In S5, in response to that the permission determination unit 103 determines to permit transmission of the specific radio wave in S4 (YES in S5), the process proceeds to S6. In S5, in response to that the permission determination unit 103 determines not to permit transmission of the specific radio wave in S4 (NO in S5), the process proceeds to S8.

In S6, the radio control unit 104 starts a process of periodically transmitting information on the specific radio wave from the transmission antenna 40. In S7, when it is the end timing of the transmission-related process (YES in S7), the transmission-related process is ended. When it is not the end timing of the transmission-related process (NO in S7), the process returns to S6 and the process is repeated. That is, until the power of the subject vehicle is turned off, the process of periodically transmitting information on the specific radio wave from the transmission antenna 40 is repeated.

In S8, the radio control unit 104 prohibits the output of the specific radio wave from the transmitting antenna 40 to stop transmission of the specific radio wave. In S9, when it is the end timing of the transmission-related process (YES in S9), the transmission-related process is ended. When it is not the end timing of the transmission-related process (NO in S9), the process returns to S8 and the process is repeated. In other words, the transmission of the specific radio wave is stopped until the power of the subject vehicle is turned off.

According to the configuration of the first embodiment, when it is determined that the current position of the subject vehicle is outside the predetermined specific area in which use of the specific radio wave is permitted, transmission of the specific radio wave is stopped. Therefore, even if the user does not turn off the power of the vehicular communication device 10, it is possible to stop the output of the specific radio wave outside the specific area. When it is determined that the current position of the subject vehicle is inside the specific area in which use of the specific radio wave is permitted, it is possible to periodically transmit information on the specific radio wave without stopping the specific radio wave. Therefore, it is possible to suppress the output of radio wave that is not permitted to be used while saving the effort of the user.

According to the configuration of the first embodiment, from power-on to power-off of the subject vehicle, whether or not to stop transmission of the specific radio wave is fixed according to the determination result by the permission determination unit 103 when the power of the subject vehicle is turned on. Therefore, the processing load can be reduced as compared with a configuration in which the permission determination unit 103 sequentially determines whether the current position of the subject vehicle is inside or outside the specific area during a trip from power-on to power-off of the subject vehicle.

### Second Embodiment

In the configuration described in the first embodiment, whether or not to stop transmission of the specific radio wave is fixed from power-on to power-off of the subject vehicle according to the determination result by the permission determination unit 103 when the power of the subject vehicle is turned on. However, the present disclosure is not limited to this configuration. In a second embodiment, during the trip from power-on to power-off of the subject vehicle, whether the current position is inside or outside the specific area is sequentially determined each time the current position of the subject vehicle is specified, and whether or not to stop transmission of the specific radio wave is dynamically switched according to the determination result of the sequential determination.

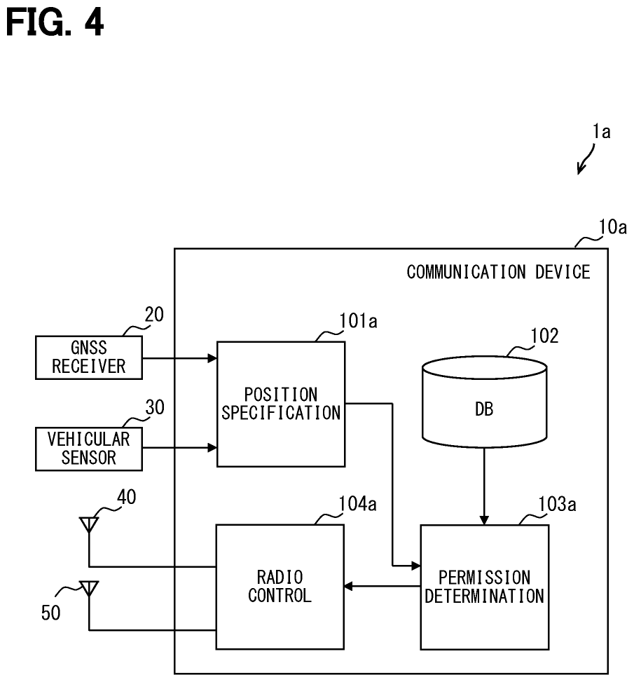

The second embodiment of the present disclosure will be described with reference to the drawings. The vehicular system 1a shown in FIG. 4 is used in a vehicle. As shown in FIG. 4, the vehicular system 1a includes a vehicular communication device 10a, a GNSS receiver 20, a vehicle sensor 30, a transmission antenna 40, and a reception antenna 50. The vehicular system 1a is similar to the vehicular system 1 of the first embodiment except that the vehicular communication device 10a is included instead of the vehicular communication device 10.

Subsequently, an example of the schematic configuration of the vehicular communication device 10a will be described with reference to FIG. 4. As shown in FIG. 4, the vehicular communication device 10a includes a position specification unit 101a, a permitted area DB 102, a permission determination unit 103a, and a radio control unit 104a as functional blocks. The vehicular communication device 10a is similar to the vehicular communication device 10 of the first embodiment except that the position specification unit 101a, the permission determination unit 103a, and the radio control unit 104a are provided instead of the position specification unit 101, the permission determination unit 103, and the radio control unit 104.

Similarly to the position specification unit 101, the position specification unit 101a positions the current position of the subject vehicle by combining the positioning signal received by the GNSS receiver 20 and the yaw rate detected by the yaw rate sensor of the vehicle sensor 30 and specifies the current position of the subject vehicle. The position specification unit 101a sequentially specifies the current position of the subject vehicle during the trip from power-on to power-off of the subject vehicle. For example, the position specification unit 101a may sequentially specify the current position of the subject vehicle at a cycle of 100 msec.

Each time the position specification unit 101a specifies the current position of the subject vehicle, the permission determination unit 103 performs a radio transmission permission determination based on the current position of the subject vehicle sequentially specified by the position specification unit 101a and the transmission permitted area data read from the permitted area DB 102 in a manner similar to the radio transmission permission determination described in the first embodiment.

The radio control unit 104a is similar to the radio control unit 104 of the first embodiment except that the radio control unit 104a dynamically switches whether or not to stop transmission of the specific radio wave according to the sequential determination result of the permission determination unit 103a.

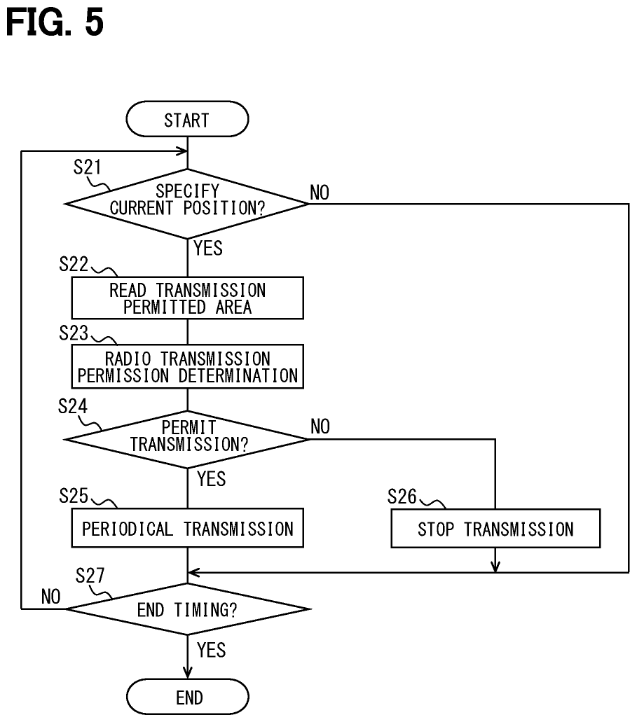

An example of a flow of the transmission-related process in the vehicular communication device 10a will be described with reference to the flowchart of FIG. 5. The vehicular communication device 10a may start the flowchart of FIG. 5 when the power of the subject vehicle is turned on.

In S21, when the current position of the subject vehicle is specified by the position specification unit 101a (YES in S21), the process proceeds to S22. When the current position of the subject vehicle is not specified by the position specification unit 101a (NO in S21), the process proceeds to S27.

In S22, the permission determination unit 103a reads the transmission permitted area data from the permitted area DB 102. In S23, the permission determination unit 103a determines whether the current position of the subject vehicle is inside or outside the specific area from the current position of the subject vehicle specified in S21 and the transmission permitted area data read in S22. Then, when the permission determination unit 103a determines that the current position of the subject vehicle is inside the specific area, the permission determination unit 103a determines to permit transmission of the specific radio wave. When the permission determination unit 103a determines that current position of the subject vehicle is outside the specific area, the permission determination unit 103a determines not to permit transmission of the specific radio wave.

In S24, in response to that the permission determination unit 103a determines to permit transmission of the specific radio wave in S23 (YES in S24), the process proceeds to S25. In S24, in response to that the permission determination unit 103a determines not to permit transmission of the specific radio wave in S23 (NO in S24), the process proceeds to S26.

In S25, the radio control unit 104a starts a process of periodically transmitting information on the specific radio wave from the transmission antenna 40, and the process proceeds to S27. In S26, the radio control unit 104a prohibits the output of the specific radio wave from the transmission antenna 40 to stop transmission, and the process proceeds to S27.

In S27, when it is the end timing of the transmission-related process (YES in S27), the transmission-related process is ended. When it is not the end timing of the transmission-related process (NO in S27), the process returns to S21 and the process is repeated. As a result, even when the permission determination unit 103a once determines to permit transmission of the specific radio wave and the radio control unit 104a periodically transmits the information on the specific radio wave from the transmission antenna 40, if the permission determination unit 103a newly determines not to permit transmission of the specific radio wave, the radio control unit 104a switches to stop transmission of the specific radio wave. Even when the permission determination unit 103a once determines not to permit transmission of the specific radio wave and the radio control unit 104a stops transmission of the specific radio wave, if the permission determination unit 103a newly determines to permit transmission of the specific radio wave, the radio control unit 104a switches to periodically transmit information on the specific radio wave from the transmission antenna 40. An example of the end timing of the transmission-related process is that the power of the subject vehicle is turned off.

Also in the configuration of the second embodiment, as in the first embodiment, the specific radio wave is stopped according to the determination result of whether the current position of the subject vehicle is inside or outside the specific area. Therefore, it is possible to suppress the output of the radio wave that is not permitted to be used while saving the effort of the user.

According to the configuration of the second embodiment, during the trip from power-on to power-off of the subject vehicle, the permission determination unit 103a sequentially determines whether the current position of the subject vehicle is inside or outside the specific area, and whether or not to stop transmission of the specific radio wave is dynamically switched according to the determination result of the sequential determination. Therefore, it is possible to suppress the output of radio wave that is not permitted to be used in finer detail and at a necessary timing according to the sequential change of the current position of the subject vehicle as the subject vehicle travels.

### Third Embodiment

In a third embodiment, the configuration described in the first embodiment and the configuration described in the second embodiment are combined.

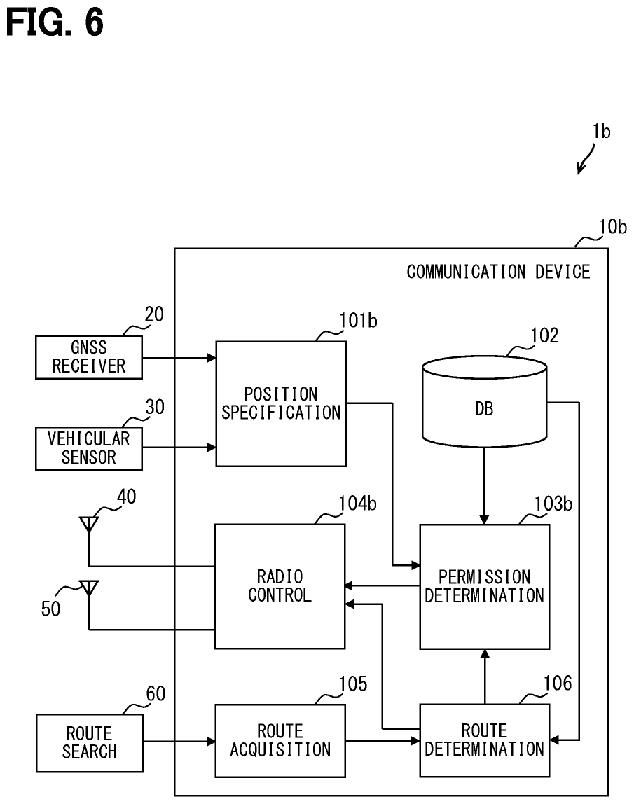

Hereinafter, the third embodiment of the present disclosure will be described with reference to the drawings. The vehicular system 1b shown in FIG. 6 is used in a vehicle. As shown in FIG. 6, the vehicular system 1b includes a vehicular communication device 10b, a GNSS receiver 20, a vehicle sensor 30, a transmission antenna 40, a reception antenna 50, and a route search device 60. The vehicular system 1b is similar to the vehicular system 1 of the first embodiment except that the vehicular communication device 10b is included instead of the vehicular communication device 10 and the route search device 60 is included.

The route search device 60 searches for a route that satisfies conditions such as time priority and distance priority to the destination of the subject vehicle based on a departure point and a destination point of the subject vehicle, which are set, and map data. The route search device 60 may be an in-vehicle device such as an in-vehicle navigation device, a mobile terminal having a navigation function that can be brought into the vehicle, or a server device outside the vehicle. When the mobile terminal or the server device outside the vehicle is used as the route search device 60, the route search device 60 is not included in the vehicular system 1b. When the mobile terminal is used as the route search device 60, the vehicular system 1b may include a communication module for performing short-range wireless communication with the mobile terminal. When the server device is used as the route search device 60, the vehicular system 1b may include a communication module for communicating with the server device via a network.

The departure point and the destination point may be set according to the operation input received from the user via a human machine interface (HMI). As for the departure point, when the route search device 60 is mounted on the vehicle, the current position of the subject vehicle may be used. The current position of the subject vehicle may be specified by the position specification unit 101b described later, or may be specified by a locator different from the position specification unit 101b. The route search may be performed by, for example, Dijkstra's algorithm. The route searched by the route search device 60 is used for route guidance of the subject vehicle. A display for the route guidance of the subject vehicle may be a display device provided in the subject vehicle, or a display device of the mobile terminal.

Subsequently, an example of the schematic configuration of the vehicular communication device 10b will be described with reference to FIG. 6. As shown in FIG. 6, the vehicular communication device 10b includes a position specification unit 101b, a permitted area DB 102, a permission determination unit 103b, a radio control unit 104b, a planned route acquisition unit 105, and a route determination unit 106 as functional blocks. The vehicular communication device 10b is similar to the vehicular communication device 10 of the first embodiment except that the position specification unit 101b, the permission determination unit 103b, and the radio control unit 104b are included instead of the position specification unit 101, the permission determination unit 103, and the radio control unit 104, and the planned route acquisition unit 105 and the route determination unit 106 are included.

The planned route acquisition unit 105 acquires a route searched by the route search device 60. That is, the planned route acquisition unit 105 acquires the planned route for providing route guidance for the subject vehicle. The route determination unit 106 determines whether or not the planned route exceeds the specific area from the planned route acquired by the planned route acquisition unit 105 and the transmission permitted area data read from the permitted area DB 102. As an example, when the point group of the coordinates of all the nodes included in the planned route crosses the boundary of the specific area, it may be determined that the planned route exceeds the specific area. When the point group of the coordinates of all the nodes included in the planned route does not cross the boundary of the specific area, it may be determined that the planned route does not exceed the specific area.

In a manner similar to the position specification unit 101a, the position specification unit 101b sequentially specifies the current position of the subject vehicle by combining the positioning signal received by the GNSS receiver 20 and the yaw rate detected by the yaw rate sensor of the vehicular sensor 30. In order to reduce the processing load, when the route determination unit 106 determines that the planned route does not exceed the specific area, the position specification unit 101b may be configured to specify the current position of the subject vehicle when the power of the subject vehicle is turned on, and then not to specify the current position of the subject vehicle again until the power of the subject vehicle is turned off.

The permission determination unit 103b performs radio transmission permission determination from the current position of the subject vehicle specified by the position specification unit 101b and the transmission permitted area data read from the permitted area DB 102 in a manner similar to the radio transmission permission determination described in the first embodiment. When the route determination unit 106 determines that the planned route does not exceed the specific area, the permission determination unit 103b performs the radio transmission permission determination when the power of the subject vehicle is turned on, in a manner similar to the permission determination unit 103 of the first embodiment. Then, the determination result by the permission determination unit 103b is held until the power of the subject vehicle is turned off. When the route determination unit 106 determines that the planned route exceeds the specific area, the permission determination unit 103b performs the radio transmission permission determination each time the position specification unit 101b specifies the current position of the subject vehicle, in a manner similar to the permission determination unit 103a of the second embodiment.

When the route determination unit 106 determines that the planned route does not exceed the specific area, the radio control unit 104b fixes whether or not to stop transmission of the specific radio wave from power-on to power-off of the subject vehicle according to the determination result of the radio transmission permission determination by the permission determination unit 103b when the power of the subject vehicle is turned on, in a manner similar to the radio control unit 104 of the first embodiment. When the route determination unit 106 determines that the planned route exceeds the specific area, the radio control unit 104b dynamically switches whether or not to stop transmission of the specific radio wave according to the sequential determination result by the permission determination unit 103b, in a manner similar to the radio control unit 104a of the second embodiment.

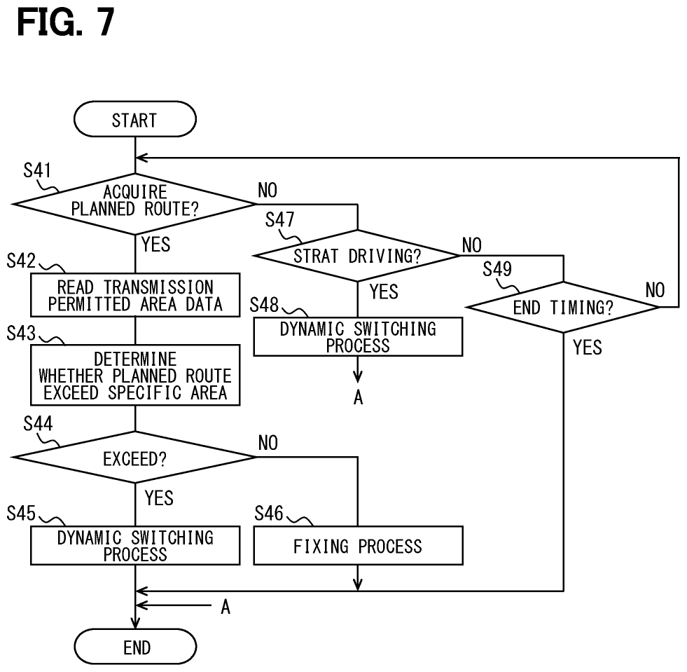

An example of a flow of the transmission-related process in the vehicular communication device 10b will be described with reference to the flowchart of FIG. 7. The vehicular communication device 10b may start the flowchart of FIG. 7 when the power of the subject vehicle is turned on.

In S41, when the planned route acquisition unit 105 has acquired the planned route (YES in S41), the process proceeds to S42. When the planned route acquisition unit 105 has not acquired the planned route (NO in S41), the process proceeds to S47.

In S42, the permission determination unit 103b reads the transmission permitted area data from the permitted area DB 102. In S43, the route determination unit 106 determines whether or not the planned route exceeds the specific area from the planned route acquired in S41 and the transmission permitted area data read in S42.

In S44, when the route determination unit 106 determines in S43 that the planned route exceeds the specific area (YES in S44), the process proceeds to S45. When the route determination unit 106 determines in S43 that the planned route does not exceed the specific area (NO in S44), the process proceeds to S46.

In S45, a process similar to the process in the flowchart of FIG. 5 of the second embodiment (hereinafter, dynamic switching process) is performed, and then the transmission-related process is ended. In the dynamic switching process, whether or not to stop transmission of the specific radio wave is dynamically switched according to the determination result of the sequential determination by the permission determination unit 103b.

In S46, a process similar to the process in the flowchart of FIG. 3 of the first embodiment (hereinafter, fixing process) is performed, and then the transmission-related process is ended. In the fixing process, from power-on to power-off of the subject vehicle, whether or not to stop transmission of the specific radio wave is fixed according to the determination result by the permission determination unit 103b when the power of the subject vehicle is turned on.

In S47, when the driving of the subject vehicle starts (YES in S47), the process proceeds to S48. If the driving of the subject vehicle does not start (NO in S47), the process proceeds to S49. Whether or not the driving of the subject vehicle starts may be determined by the vehicular communication device 10b from the sensing result of the vehicular sensor 30. As an example, it may be determined that the vehicle starts driving when a shift position detected by a shift position sensor becomes a driving position. As another example, it may be determined that the vehicle starts driving when the parking brake switch signal is turned off.

It is preferable that the vehicular communication device 10b determines whether or not the driving of the subject vehicle starts before the subject vehicle actually starts driving in order not to reduce the responsiveness from the start of the driving of the subject vehicle to the start of transmission of information on the specific radio wave.

In S48, the above-described dynamic switching process is performed, and then transmission-related process is ended. Although the configuration in which the dynamic switching process is performed in S48 is shown here, it is not necessarily limited to this configuration. For example, the above-described fixing process may be performed in S48.

In S49, when it is the end timing of the transmission-related process (YES in S49), the transmission-related process is ended. When it is not the end timing of the transmission-related process (NO in S49), the process returns to S41 and the process is repeated. An example of the end timing of the transmission-related process is that the power of the subject vehicle is turned off.

Also in the configuration of the third embodiment, as in the first embodiment and the second embodiment, the specific radio wave is stopped according to the determination result of whether the current position of the subject vehicle is inside or outside the specific area. Therefore, it is possible to suppress the output of the radio wave that is not permitted to be used while saving the effort of the user.

When the planned route of the subject vehicle exceeds the specific area, the following cases may occur if whether or not to stop transmission of the specific radio wave is fixed from power-on to power-off of the subject vehicle. For example, when the subject vehicle travels from the inside of the specific area to the outside of the specific area, the radio wave that is not permitted to be used is output outside the specific area. In addition, when the subject vehicle travels from the outside of the specific area to the inside of the specific area due to the driving of the subject vehicle, it is possible to prevent the output of radio wave that is not permitted to be used outside the specific area, but the radio wave is not output even inside the specific area. When the planned route of the subject vehicle does not exceed the specific area, since it is unlikely that the determination result of whether the current position of the subject vehicle is inside or outside the specific area will fluctuate, the sequential determination may increase an unnecessary processing load.

According to the configuration of the third embodiment, when it is determined that the planned route of the subject vehicle exceeds the specific area, the permission determination unit 103b sequentially determines whether the current position of the subject vehicle is inside or outside the specific area during the trip from power-on to power-off of the subject vehicle, and whether or not to stop transmission of the specific radio wave is dynamically switched according to the determination result of the sequential determination. When it is determined that the planned route of the subject vehicle does not exceed the specific area, whether or not to stop transmission of the specific radio wave is fixed from power-on to power-off of the subject vehicle according to the determination result by the permission determination unit 103b when the power of the subject vehicle is turned on. Therefore, it is possible to suppress the output of the radio wave that is not permitted to be used as necessary and prevent unnecessary increase in processing load by selecting to fix whether or not to stop transmission of the specific radio wave, or to dynamically switch whether or not to stop transmission of the specific radio wave.

In the configuration described in the third embodiment, fixing whether or not to stop transmission of the specific radio wave or dynamically switching whether or not to stop transmission of the specific radio wave is selected based on whether or not the planned route of the subject vehicle exceeds the specific area. However, the present disclosure is not limited to this configuration. In another configuration, fixing whether or not to stop transmission of the specific radio wave or dynamically switching whether or not to stop transmission of the specific radio wave may be selected based on any condition that can distinguish whether the possibility of the subject vehicle exceeding the specific area is high or low other than whether or not the planned route of the subject vehicle exceeds the specific area.

For example, while the power of the subject vehicle is on, when the distance from the current position of the subjected vehicle specified by the position specification unit 101b to the nearest boundary of the specific area is less than a threshold value, it can be regarded that the possibility of the subject vehicle exceeding the specific area is high, and whether or not to stop transmission of the specific radio wave may be dynamically switched. When the distance from the current position of the subjected vehicle to the nearest boundary of the specific area is greater than the threshold value, it can be regarded that the possibility of the subject vehicle exceeding the specific area is low, and whether or not to stop transmission of the specific radio wave may be fixed. The threshold value referred to here may be set to any value as long as it is a value that can distinguish whether or not the subject vehicle exceeds the specific area.

### Fourth Embodiment

In the configurations described in the above embodiments, the permission determination units 103, 103a, 103b determine whether the current position of the subject vehicle is inside or outside the specific area to determine whether or not to permit transmission of the specific radio wave. However, the present disclosure is not limited to these configuration. For example, the permission determination unit 103, 103a, 103b may be configured not to determine whether or not to permit transmission of the specific radio wave.

In such a case, the permission determination units 103, 103a, 103b may output the determination result of determining whether the current position of the subject vehicle is inside or outside the specific area to the radio control units 104, 104a, 104b. Then, the radio control units 104, 104a, 104b may be configured not to stop transmission of the specific radio wave when it is determined that the current position of the subject vehicle is inside the specific area, and to stop transmission of the specific radio wave when it is determined that the current position of the subject vehicle is outside the specific area.

### Fifth Embodiment

In the configurations described in the above embodiments, the vehicular communication devices 10, 10a, 10b position the current position of the subject vehicle and specify the current position of the subject vehicle by combining the positioning signal received by the GNSS receiver 20 and the yaw rate detected by the yaw rate sensor of the vehicular sensor 30. However, the present disclosure is not limited to these configurations. For example, the vehicular communication devices 10, 10a and 10b acquire the current position of the subject vehicle determined by a locator other than the vehicular communication devices 10, 10a and 10b, and the position specification units 101, 101a, 101b may specify the acquired current position of the subject vehicle as the current position of the subject vehicle.

The position specification unit 101, 101a, 101b corresponds to a position specifier of the present disclosure. The permission determination units 103, 103a, 103b correspond to the inside-outside determiner of the present disclosure. The radio control units 104, 104a, 104b correspond to the transmission controller of the present disclosure.

It is noted that a flowchart or the process of the flowchart in the present disclosure includes multiple steps (also referred to as sections), each of which is represented, for example, as S1. Further, each step can be divided into several sub-steps while several steps can be combined into a single step.

Note that the present disclosure is not limited to the embodiments described above and can variously be modified within the scope of the disclosure. An embodiment obtained by appropriately combining the technical means disclosed in the different embodiments is also included in the technical scope of the present disclosure. The vehicular communication devices 10, 10a, 10b and the control method described in the present disclosure may be implemented by a special purpose computer which includes a processor programmed to execute one or more functions executed by computer programs. Alternatively, the vehicular communication devices 10, 10a, 10b and the control method described in the present disclosure may be implemented by a special purpose hardware logic circuit. Alternatively, the vehicular communication devices 10, 10a, 10b and the control method described in the present disclosure may be implemented by one or more special purpose computers configured by a combination of a processor executing a computer program product and one or more hardware logic circuits. The computer program product may be stored, as instructions to be executed by a computer, in a tangible non-transitory computer-readable medium.

What is claimed is:

1. A vehicular communication device to be used for a vehicle, comprising:
a transmission controller configured to periodically transmit information on a radio wave in a predetermined frequency band;
a position specifier configured to specify a current position of the vehicle;
an inside-outside determiner configured to determine whether the current position of the vehicle specified by the position specifier is inside or outside a specific area in which use of the radio wave is permitted, wherein
the transmission controller is further configured:
not to stop transmission of the radio wave in response to that the inside-outside determiner determines that the current position of the vehicle is inside the specific area; and
to stop transmission of the radio wave in response to that the inside-outside determiner determines that the current position of the vehicle is outside the specific area.

2. The vehicular communication device according to claim 1, wherein
the position specifier is further configured to sequentially specify the current position of the vehicle,
the inside-outside determiner is further configured to sequentially determine whether the current position is inside or outside the specific area each time the position specifier specifies the current position of the vehicle, and
the transmission controller is further configured to dynamically switching whether or not to stop the transmission of the radio wave based on a sequential determination result of the inside-outside determiner.

3. The vehicular communication device according to claim 1, wherein
the inside-outside determiner is further configured to determine whether the current position of the vehicle is inside or outside the specific area when a power of the vehicle is turned on, and
the transmission controller is further configured to fix whether or not to stop the transmission of the radio wave from power-on to power-off of the vehicle based on a determination result of the inside-outside determiner when the power of the vehicle is turned on.

4. The vehicular communication device according to claim 1, wherein
the position specifier is further configured to sequentially specify the current position of the vehicle,
the inside-outside determiner is capable of sequentially determining whether the current position of the vehicle specified by the position specifier is inside or outside the specific area each time the position specifier specifies the current position of the vehicle, and determining whether the current position of the vehicle specified by the position specifier when a power of the vehicle is turned on is inside or outside the specific area, and
the transmission controller is capable of selecting to dynamically switch whether or not to stop the transmission of the radio wave based on a sequential determination result by the inside-outside determiner or to fix whether or not to stop the transmission of the radio wave based on a determination result of the inside-outside determiner when the power of the vehicle is turned on.

5. The vehicular communication device according to claim 4, further comprising:
a planned route acquirer configured to acquire a planned route for route guidance of the vehicle; and
a router determiner configured to determine whether or not the planner route acquired by the planned route acquirer exceeds the specific area, wherein
the transmission controller is further configured to fix whether or not to stop the transmission of the radio wave from power-on to power-off of the vehicle based on a determination result of the inside-outside determiner when the power of the vehicle is turned on in response to that the route determiner determines that the planned route does not exceed the specific area, and to dynamically switch whether or not to stop the transmission of the radio wave based a sequential determination result by the inside-outside determiner in response to that the route determiner determines that the planned route exceeds the specific area.

6. The vehicular communication device according to claim 1, wherein
the transmission controller is further configured to periodically transmit information on the radio wave to perform vehicle-to-vehicle communication between the vehicle and a peripheral vehicle.

7. A communication method to be used for a vehicle, comprising:
specifying a current position of the vehicle;
determining whether the current position of the vehicle is inside or outside a specific area in which use of a radio wave in a predetermined frequency band is permitted;
periodically transmitting information on the radio wave in response to determining that the current position of the vehicle is inside the specific area; and
stopping transmission of the radio wave in response to determining that the current position of the vehicle is outside the specific area.

8. A control program product stored on a non-transitory computer-readable medium and comprising instructions configured to, when executed by a computer, cause the computer to:
specify a current position of a vehicle;
determine whether the current position of the vehicle is inside or outside a specific area in which use of a radio wave in a predetermined frequency band is permitted;
periodically transmit information on the radio wave in response to determining that the current position of the vehicle is inside the specific area; and
stop transmission of the radio wave in response to determining that the current position of the vehicle is outside the specific area.

9. The vehicular communication device according to claim 1, further comprising
a processor and a memory, wherein
the memory stores instructions configured to, when executed by the processor, cause the processor to operate as the transmission controller, the position specifier, and the inside-outside determiner.
